(19) United States
(12) Patent Application Publication
(10) Pub. No.: US 2009/0105856 A1
(43) Pub. Date: Apr. 23, 2009

(54) METHOD AND DEVICE FOR PROVIDING A LIGHTING SETTING FOR CONTROLLING A LIGHTING SYSTEM TO PRODUCE A DESIRED LIGHTING EFFECT

(75) Inventors: Ralph Kurt, Eindhoven (NL); Eduard Johannes Meijer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,542

(22) PCT Filed: Aug. 28, 2006
(86) PCT No.: PCT/IB06/52976

§ 371 Date: Jul. 22, 2008

(30) Foreign Application Priority Data
Sep. 6, 2005 (EP) 05108144.6

(51) Int. Cl. H05B 37/02

(52) U.S. Cl. 700/90

(57) ABSTRACT

The present invention relates to a method for providing a lighting setting for controlling a lighting system (10a, 10b) to produce a desired lighting effect. The method comprises, in a remote server (24), receiving data related to the lighting system and generating a lighting setting related to the desired lighting effect and adapted according to the received lighting system data, and sending the adapted lighting setting from the remote server to the lighting system. Thus, when the lighting system receives the lighting setting, the lighting setting is already adapted according to that specific lighting system, whereby the desired lighting effect can be produced correctly. There is no immediate need for any post download adjustment of the light setting. The invention also relates to a corresponding remote server.

The present invention relates to a method and a device, namely a remote server, for providing a lighting setting for controlling a lighting system to produce a desired lighting effect.

Lighting systems, for example lighting systems comprising light emitting diodes, can be used in various applications for various purposes. Lighting systems can for example be used at home to create an atmospheric lighting effect or illumination in a room, or as disco light at a club venue. In another application, lighting systems can be used in mobile phones to indicate a certain event, such as an incoming call or a received message.

The lighting systems can be fairly comprehensive and complicated, comprising a plurality of light sources. Therefore, a controller running a lighting scheme or lighting settings is needed to control the light sources in order to create a coherent and/or coordinated lighting effect. These lighting schemes can be resident in the controller, or be downloaded from for example the Internet. Examples of the latter are disclosed for instance in the documents US2004/0252486 (downloadable and pre-programmed light shows for lighting equipment) and WO03/0775505 (sequences for the activation of lights in a mobile phone may be downloaded to the mobile).

However, a drawback with the systems and methods disclosed in the documents mentioned above is that the downloaded lighting scheme may not fit the user's lighting system. For example, the user's lighting system may comprise a different number of light sources, different types of light sources, etc., compared to the lighting system the downloaded lighting scheme was optimized for. Also, the environment the user's lighting system is installed in may affect how the downloaded lighting scheme is perceived. For example, a downloaded preset lighting scheme may be perceived as having too low intensity when it is run on a user's lighting system, which is installed, in a very bright environment.

This all means that the downloaded lighting scheme may have to be adapted, either manually by the user or automatically by the lighting system's controller (as in US2004/0252486), before working and being shown correctly on the user's specific lighting system. This local adaptation of course is time consuming, and may, if carried out wrong, result in that the lighting effect is not shown as desired or intended.

It is an object of the present invention to overcome this problem, and to provide improved means for providing a lighting setting for controlling a lighting system to produce a desired lighting effect.

This and other objects that will be evident from the following description are achieved by means of a method and a device, according to the appended claims.

According to an aspect of the invention, there is provided a method for providing a lighting setting for controlling a lighting system to produce a desired lighting effect, the method comprising: in a remote server, receiving data related to the lighting system and generating a lighting setting related to the desired lighting effect and adapted according to the received lighting system data, and sending the generated lighting setting from the server to the lighting system.

Thus, when the lighting system receives the lighting setting, the lighting setting is already adapted according to that specific lighting system, whereby the desired lighting effect can be produced correctly. There is no immediate need for any post download adjustment of the light setting. The adaptation that is being carried out in the controller of the lighting system in WO2004/0252486 has thus been delegated in the invention to the remote server.

The lighting system preferably comprises a plurality of light sources, for example light emitting diodes. Further, the lighting system concerned can for example be a lighting system provided in a portable electronic device such as a mobile phone, electrical shaver, toothbrush, etc., in order to indicate a certain event, such as in the case of a mobile phone an incoming call or a received message, or a lighting system for creating light shows at a theatre, concert, nightclub, etc. Alternatively, the lighting system is for illumination or creating lighting effects in a room.

The lighting system data can be at least one of lighting system setup, lighting system environment, and user preference. Lighting system setup data can for example include the number-, location-, direction-, beam shape capability- and color gamut of the light sources of the lighting system. Lighting system environment data is foremost relevant when the lighting system is provided in a room or similar, and can for example include room layout, furniture, curtains, windows, etc. User preference data can for example include user feedback on previously downloaded lighting settings. A lighting setting adapted according to lighting system setup, lighting system environment, and/or user preference in most cases produces a better result than a standard, non-customized, lighting setting.

“Adapted” lighting setting should be construed as a lighting setting that is customized and/or optimized for the specific system and the system's environment it is intended to, and/or personalized or selected according to user preference.

In one embodiment, the lighting system data is stored in a database connected to the remote server. Preferably, the database is incorporated in the remote server. The remote server and database can for example be hosted by a service provider offering lighting settings for various lighting effects to a plurality of lighting systems. Thus, data related to plurality of different lighting systems can be stored in the database.

The lighting system data can be sent or uploaded to the database or the remote server from one of the lighting system and a remote device via a communications network. Thus, in one embodiment, there is bi-directional communication between the lighting system and the remote server. Lighting system data can be uploaded, and customized lighting settings can be downloaded. The lighting system can be directly connected to the remote server via for example the Internet or a telecommunications network, or the lighting system can be connected to for example a computer controlling the lighting system, which computer in turn is connected to the remote server.

In another embodiment, lighting system data is uploaded to the database or the remote server from another remote device, such as a point of sales station. Lighting system data can for example initially be uploaded from a point of sales station to the remote server upon purchase of the lighting system.

At any time, new lighting system data can be uploaded for updating existing lighting system data, if for example the lighting system is extended, moved to another location, etc. This offers the advantage that the lighting setting always will be adapted according to the current conditions.

For the purpose of setting and/or update user preference data, such data can for example be recorded by allowing a user to preview the lighting effect produced by the downloaded lighting setting on the lighting system, and allowing the user to accept or reject the lighting setting. Whether the user accepts or rejects the lighting control setting is a record of user preference, which can be uploaded to the remote server and stored in the database. Alternatively, or as a complement, the user preference can be recorded by allowing a user to manually adjust the downloaded lighting setting. The manual adjustment is a record of user preference. The recording of user preference for setting/updating user reference data works as an iterative feedback process, featuring bi-directional communication between on one hand the user and the lighting system and on the other hand the remote server providing the lighting settings. The feedback process allows a service provider to keep record of the user's selection behavior, and consider the user's past selection behavior next time settings are provided to the user. For example, the service provider can avoid sending certain settings to a user who has previously rejected similar settings.

In one embodiment, (adapted) lighting settings are generated and sent to the lighting system according to a preset schedule. This allows lighting settings to be regularly sent to the lighting system on a subscription type basis. The schedule can for example be set by the service provider.

In another embodiment, the (adapted) lighting setting is generated based on a received request for a desired lighting effect. That is, the lighting setting is generated and downloaded on demand. The request can be for a specific lighting effect, or for a lighting effect of a certain category or type. Further, the request can for example be sent directly from the lighting system, or from a remote device, such as a mobile phone. The request should include an identification number or similar specifying which lighting system the request is valid for, so that the remote server can derive the correct lighting setting adapted for that system and download the setting to the correct system. Additionally, the request can comprise data related to the lighting system. This is advantageous if the lighting system data previously was not recorded in the remote server.

In yet another embodiment, the (adapted) lighting setting is generated based on a previously received lighting setting, which previously received lighting setting is related to the desired lighting effect but adapted according to different lighting system data. That is, the received lighting setting can be adapted to another lighting system. In this way, a user can send lighting settings to another user via the remote server, which remote server adapts the lighting setting according to the another user's specific lighting system.

According to another aspect of the invention, there is provided a remote server for providing a lighting setting for controlling a lighting system to produce a desired lighting effect, which remote server comprises means for receiving data related to the lighting system, means for generating a lighting setting related to the desired lighting setting and adapted according to the received lighting system data, and means for sending the generated lighting setting to the lighting system. The lighting system data is preferably stored in a database incorporated in the remote server. This remote server offers similar advantages as the previously discussed aspect of the invention.

These and other aspects of the present invention will now be described in more detail, with reference to the appended drawing showing a currently preferred embodiment of the invention.

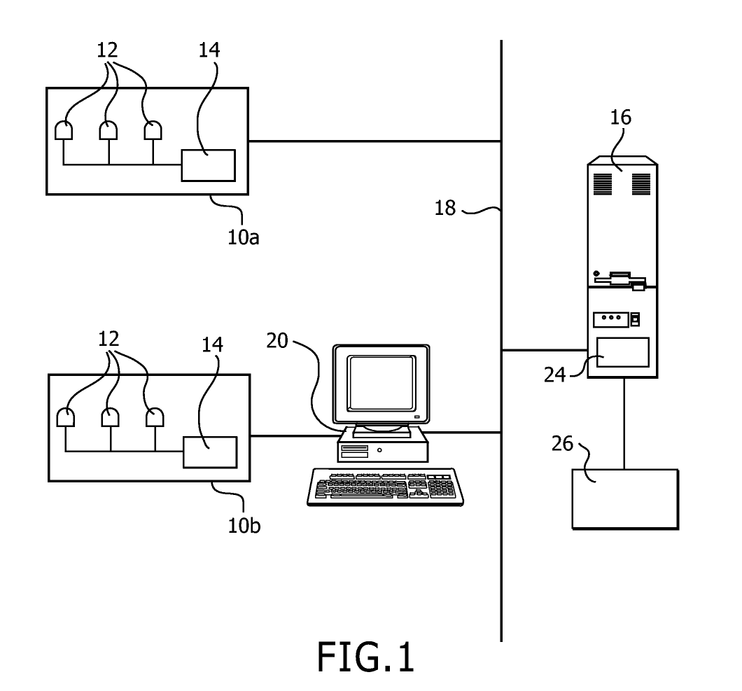

FIG. 1 is a block diagram of systems for realizing the method according to an embodiment of the invention.

FIG. 1 shows two lighting systems 10a and 10b. The lighting systems can for example be provided in a room in order to create an atmospheric lighting effect or illumination, or in a portable electronic device such as a mobile phone in order to indicate a certain event, such as an incoming call or a received message.

Each lighting system 10 comprises a plurality of light sources 12 connected to a controller 14. The controller 14 controls the light sources 12 in accordance with a lighting setting to produce a desired coherent and/or coordinated lighting effect. The light sources 12 can for example be light emitting diode (LED) light sources.

The lighting system 10a is directly connected to a remote server 16 via a communications link 18, such as the Internet, a wired or wireless telecommunications network, etc. The lighting system 10a preferably includes a suitable user interface (not shown) for allowing a user to manage the communication with the remote server 16.

The lighting system 10b on the other hand is connected to a computer 20, which in turn is connected to the remote server 16 via the communications link 18. The computer 20 works an intermediary between the lighting system 10b and the remote server 16, and is used to manage the communication there between.

The remote server 16 comprises a database 24 storing data related to a plurality of specific lighting systems (“lighting system data”), including lighting systems 10a and 10b, to which the remote server provides lighting settings. The lighting system data can include lighting system setup data (including the number-, location-, direction-, beam shape capability and/or color gamut of the light sources of the lighting system), lighting system environment data (room layout, furniture, curtains, windows, etc.), and user preference data (for example based on feedback). The server 16 also comprises suitable means for receiving and sending various data.

In a basic mode of operation, lighting settings can be sent from the remote server 16 to the lighting systems 10 via the communications link 18. When the lighting setting has been downloaded to the lighting system 10, the controller 14 can control the light sources 12 in accordance with the downloaded lighting setting to produce a lighting effect. In the end, several lighting settings can be stored locally for the lighting system, allowing a user to toggle between several different lighting effects.

According to the invention, prior to sending, the remote server receives any data related to that specific lighting system, and generates a lighting setting adapted according to the retrieved lighting system data. That is, before it is sent to the lighting system, the lighting setting is optimized in accordance with lighting system setup, lighting system environment, and/or any user preferences for the lighting system in question. In a preferred embodiment, the lighting system data is received from the internal database 24.

Lighting system 10a can for example comprise a different number of light sources and/or different types of light sources compared to the lighting system 10b. This means that if the same standardized lighting setting should be sent to the lighting systems 10a and 10b, the produced lighting effect would appear quite different on the two systems. The lighting effect would most likely not be produced as desired on at least one of the systems, whereby it would be necessary for the user or the lighting system to adjust the downloaded lighting setting in order to achieve the desired lighting effect. However, according to the invention, the lighting settings are prior to sending customized according to each specific lighting system 10a and 10b based on the relevant lighting system data in the database 24. Consequently, in this particular case, two different lighting settings are sent for the same lighting effect, and there is no immediate need for any post download adjustment of the light setting.

Data relating to a specific lighting system can initially be entered into the database 24 for example upon purchase of the lighting system. Data can for example be uploaded from a remote device 26, such as point of sales station. The data in the database 24 can later be updated, if for example the lighting system is extended, moved to another location, etc. New lighting system data can for example be sent from the lighting system 10 to the database 24 of the remote server 16.

A user feedback function can also be provided in relation to the lighting system, allowing user preference data to be stored and updated in the database 24. The user preference data can then be utilized in order to adapt the lighting settings. The user feedback function can be implemented as follows:

When a lighting setting has been downloaded to the lighting system, it is executed on the lighting system so that a user can experience the corresponding lighting effect on his or hers specific lighting system in his or hers specific environment. After previewing the lighting effect, the user can accept or reject the lighting setting related to the lighting effect, that is, decide whether he or she would like to keep the downloaded lighting setting or not. Whether the user accepts or rejects the lighting control setting is a record of user preference, and this data is entered into the database 24. The data can be sent via the communications link 18. Thus, the service provider keeps record of the user's selection behavior in order to consider the user preference next time a lighting setting is provided to the lighting system.

When offering a lighting setting next time, the new setting can be chosen to be close to what is already known to meet the requirements, preferences and style of the user (if the user for instance has an original setting producing a white light and he or she accepts an offer of a slightly more bright or bluish light, he or she can be offered a setting producing an even more bright or bluish light settings), or the user can be offered another setting producing a completely different effect (far away from the already used ones) which he or she also might like. Whether a new lighting setting is “close” to or “far away” from a previous lighting setting can be defined by color coordinates, wherein “close” in defined by Δuw<0.05, preferably Δuw<0.03, and “far away” is defined by Δuw>0.1, preferably Δuw>0.2, and most preferably Δuw>0.3.

Alternatively, or as a complement, the user preference can be recorded by allowing a user to manually adjust the received lighting setting. The manual adjustment is a record of user preference, and this data can also be entered into the database 24.

Lighting settings can be generated and sent to the lighting system according to a preset schedule. This allows lighting settings to be regularly sent to the lighting system on a subscription type basis. The schedule can for example be set by the service provider hosting the remote server 16 and the database 24.

Alternatively, a lighting setting can be generated based on a received request for a desired lighting effect from a user. The request can for example be sent directly from the lighting system 10, or from a remote device 26, such as a mobile phone. The request should include an identification number or similar specifying which lighting system the request is valid for, so that the remote server can derive the correct lighting setting adapted for that system and send the setting to the correct system. Further, the request can be for a specific lighting effect, or for a lighting effect of a certain category or type. In the latter case, predefined classifications can be used in the communication between the remote server and the user. The classifications can be sent together with the above mentioned identification number. Examples of classifications are:
person (as each person may have different user preferences)
room (living room, kitchen, bedroom, bathroom, etc.)
subsystem (if several subsystems are installed in a room)
situation (breakfast, dinner, lunch, TV-matching mode, visitors, reading mode, listening music, playing games, party, cleaning, etc.)
seasonal situations (winter, spring, summer, autumn, Christmas, birthday, Valentine day, etc.)

Thus, when a new lighting setting is demanded, the user transmits the classifications of interest, for example the user may be looking for a lighting effect for a party in the living room in the summer season, whereby a new lighting setting is generated in the remote server, which setting is based on the transmitted classifications and adapted to the user's specific lighting system, and sent to the user's lighting system.

As yet another alternative, a lighting setting can be generated based on a previously received lighting setting, which previously received lighting effect is related to the desired lighting effect but adapted according to different lighting system data. In this way, a user can send lighting settings to another user via the remote server, which remote server adapts the lighting setting according to the another user's specific lighting system. For example, it may be desirable to send a lighting setting for a certain lighting effect, which lighting setting is adapted to and locally stored on the system 10a, from the system 10a to the system 10b, so that the certain lighting effect can be generated on system 10b. To realize this, the lighting setting is sent from the system 10a to the remote server 16. In the remote server 16, a lighting setting for the certain lighting effect is generated for system 10b based on the received lighting setting for system 10a. The lighting setting is subsequently sent from the remote server to system 10b. Since the setting is adapted to the specific system, it will work correctly on system 10b, even though system 10b may not be the same as system 10a.

The person skilled in the art realizes that the present invention by no means is limited to the preferred embodiments described above. On the contrary, many modifications and variations are possible within the scope of the appended claims. For example, even though only two lighting systems are illustrated in FIG. 1, the remote server can serve several more different lighting systems.

1. A method for providing a lighting setting for controlling a lighting system (10a, 10b) to produce a desired lighting effect, the method comprising:
in a remote server (16), receiving data related to said lighting system,
in the remote server, generating a lighting setting related to the desired lighting effect and adapted according to the received lighting system data; and
sending the generated lighting setting from the remote server to the lighting system.

2. Method according to claim 1, wherein said lighting system data is at least one of lighting system setup, lighting system environment, and user preference.

3. Method according to claim 1, wherein the lighting system data is stored in a database (24) connected to the remote server.

4. Method according to claim 1, wherein the lighting system data is sent to the remote server or the database from one of the lighting system and a remote device (26) via a communications network.

5. Method according to claim 2, wherein the user preference is recorded by:
allowing a user to preview the lighting effect produced by the downloaded lighting setting on the lighting system, and
allowing the user to accept or reject the lighting setting, the acceptation or rejection being a record of user preference.

6. A method according to claim 2, wherein said user preference is recorded by:
allowing a user to manually adjust the downloaded lighting setting, the manual adjustment being a record of user preference.

7. A method according to claim 1, wherein said lighting system comprises a plurality of light sources (12), preferably light emitting diode light sources.

8. A method according to claim 1, wherein lighting settings are generated and sent to the lighting system according to a preset schedule.

9. A method according to claim 1, wherein the lighting setting is generated based on a received request for a desired lighting effect.

10. A method according to claim 1, wherein the lighting setting is generated based on a previously received lighting setting, which previously received lighting setting is related to the desired lighting effect but adapted according to different light system data.

11. A remote server (16) for providing a lighting setting for controlling a lighting system to produce a desired lighting effect, comprising:
means for receiving data related to said lighting system;
means for generating a lighting setting related to the desired lighting effect and adapted according to the received lighting system data; and
means for sending the generated lighting setting to the lighting system.

12. A remote server according to claim 11, further comprising:
a database (24) storing the lighting system data.
